(19) United States
(12) Patent Application Publication
(10) Pub. No.: US 2024/0146405 A1
(43) Pub. Date: May 2, 2024

(54) CONTROL APPARATUS, COMMUNICATION SYSTEM, CONTROL METHOD, AND PROGRAM

(71) Applicant: NEC Corporation, Tokyo (JP)

(72) Inventors: Kenji WAKAFUJI, Tokyo (JP); Junichi FUNADA, Tokyo (JP); Kohei YOSHIDA, Tokyo (JP); Masakazu ONO, Tokyo (JP); Kazuyuki HAYASHI, Tokyo (JP)

(73) Assignee: NEC Corporation, Tokyo (JP)

(21) Appl. No.: 18/379,961

(22) Filed: Oct. 13, 2023

(30) Foreign Application Priority Data
Oct. 27, 2022 (JP) 2022-172779

(51) Int. Cl. H04B 7/185; H04B 7/0413

(52) U.S. Cl. CPC H04B 7/18534; H04B 7/0413

(57) ABSTRACT

A control apparatus capable of exhibiting the diversity effect in a hybrid mobile communication system using a terrestrial communication apparatus and a non-terrestrial communication apparatus is provided. A control apparatus according to the present disclosure includes a communication unit configured to communicate with a non-terrestrial communication apparatus and a terrestrial communication apparatus, an estimation unit configured to estimate a delay time of communication with a communication terminal through the non-terrestrial communication apparatus from communication with the communication terminal through the terrestrial communication apparatus, a control unit configured to, when MIMO communication is performed with the communication terminal using the non-terrestrial communication apparatus and the terrestrial communication apparatus, control an insertion timing of reference signals to be inserted into a first signal sequence transmitted to the non-terrestrial communication apparatus and a second signal sequence transmitted to the terrestrial communication apparatus, based on the delay time.

### INCORPORATION BY REFERENCE

This application is based upon and claims the benefit of priority from Japanese patent application No. 2022-172779, filed on Oct. 27, 2022, the disclosure of which is incorporated herein in its entirety by reference.

### TECHNICAL FIELD

The present disclosure relates to a control apparatus, a communication system, a control method, and a program.

### BACKGROUND ART

Recently, the application of a hybrid mobile communication system using a terrestrial communication apparatus and a non-terrestrial communication apparatus has been studied. It is expected that a diversity effect occurs when a communication terminal receives signals from a terrestrial communication apparatus and a non-terrestrial communication apparatus. This is expected to improve signal quality of signals received by the communication terminal.

Published Japanese Translation of PCT International Publication for Patent Application, No. 2011-512060 discloses a communication system including a satellite transmitter, a terrestrial base station, a satellite receiver, and a terrestrial user transceiver. In the communication system disclosed in Published Japanese Translation of PCT International Publication for Patent Application, No. 2011-512060, the terrestrial user transceiver performs MIMO (Multiple Input Multiple Output) communication with the terrestrial base station. The terrestrial user transceiver maximizes MIMO terrestrial signals received from the terrestrial base station, minimizes satellite signals received from the satellite transmitter, and reduces an interference of a satellite signal with the MIMO terrestrial signal.

### SUMMARY

However, in the communication system disclosed in Published Japanese Translation of PCT International Publication for Patent Application, No. 2011-512060, the terrestrial user transceiver minimizes the satellite signals received from the satellite transmitter. Therefore, there is a problem that the terrestrial user transceiver cannot achieve a diversity effect expected by receiving the MIMO terrestrial signals from the terrestrial base station and the satellite signals.

One of the objects of the present disclosure is to provide a control apparatus, a communication system, a control method, and a program capable of exerting the diversity effect in a hybrid mobile communication system using a terrestrial communication apparatus and a non-terrestrial communication apparatus in view of the above-mentioned problem.

A control apparatus according to a first example aspect of the present disclosure includes: a communication unit configured to communicate with a non-terrestrial communication apparatus and a terrestrial communication apparatus; an estimation unit configured to estimate a delay time of communication with a communication terminal through the non-terrestrial communication apparatus from communication with the communication terminal through the terrestrial communication apparatus; and a control unit configured to, when MIMO communication is performed with the communication terminal using the non-terrestrial communication apparatus and the terrestrial communication apparatus, control an insertion timing of reference signals to be inserted into a first signal sequence transmitted to the non-terrestrial communication apparatus and a second signal sequence transmitted to the terrestrial communication apparatus, based on the delay time.

A communication system according to a second example aspect of the present disclosure includes: a non-terrestrial communication apparatus; a terrestrial communication apparatus; and a control apparatus including: a communication unit configured to communicate with the non-terrestrial communication apparatus and the terrestrial communication apparatus; an estimation unit configured to estimate a delay time of communication with a communication terminal through the non-terrestrial communication apparatus from communication with the communication terminal through the terrestrial communication apparatus; and a control unit configured to, when MIMO communication is performed with the communication terminal using the non-terrestrial communication apparatus and the terrestrial communication apparatus, control an insertion timing of reference signals to be inserted into a first signal sequence transmitted to the non-terrestrial communication apparatus and a second signal sequence transmitted to the terrestrial communication apparatus, based on the delay time.

A control method according to a third example aspect of the present disclosure includes: estimating a delay time of communication with a communication terminal through a non-terrestrial communication apparatus from communication with the communication terminal through a terrestrial communication apparatus; and controlling, when MIMO communication is performed with the communication terminal using the non-terrestrial communication apparatus and the terrestrial communication apparatus, an insertion timing of reference signals to be inserted into a first signal sequence transmitted to the non-terrestrial communication apparatus and a second signal sequence transmitted to the terrestrial communication apparatus, based on the delay.

A program according to a fourth example aspect of the present disclosure causes a computer to execute: estimating a delay time of communication with a communication terminal through a non-terrestrial communication apparatus from communication with the communication terminal through a terrestrial communication apparatus; and controlling, when MIMO communication is performed with the communication terminal using the non-terrestrial communication apparatus and the terrestrial communication apparatus, an insertion timing of reference signals to be inserted into a first signal sequence transmitted to the non-terrestrial communication apparatus and a second signal sequence transmitted to the terrestrial communication apparatus, based on the delay time.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a configuration diagram of a control apparatus according to the present disclosure;

FIG. 2 shows a flow of communication processing executed in the control apparatus according to the present disclosure;

FIG. 3 is a configuration diagram of a communication system according to the present disclosure;

FIG. 4 is a configuration diagram of a CU/DU according to the present disclosure;

FIG. 5 shows a signal sequence received by a UE through an NTN RU and a signal sequence received by the UE through a terrestrial RU according to the present disclosure;

FIG. 6 shows a signal sequence received by the UE through the NTN RU and a signal sequence received by the UE through the terrestrial RU;

FIG. 7 shows a signal sequence transmitted from the CU/DU to the NTN RU and the terrestrial RU;

FIG. 8 shows an example of an arrangement of pilot signals in OFDM signals according to the present disclosure;

FIG. 9 is a configuration diagram of the NTN RU according to the present disclosure;

FIG. 10 is a configuration diagram of the terrestrial RU according to the present disclosure;

FIG. 11 is a configuration diagram of a UE according to the present disclosure;

FIG. 12 shows a flow of communication processing in the CU/DU according to the present disclosure;

FIG. 13 shows a flow of reception processing in the UE according to the present disclosure;

FIG. 14 is a configuration diagram of the NTN RU and the terrestrial RU according to the present disclosure;

FIG. 15 is a configuration diagram of the UE according to the present disclosure; and

FIG. 16 is a configuration diagram of a control apparatus 10 according to the present disclosure.

### EXAMPLE EMBODIMENT

### First Example Embodiment

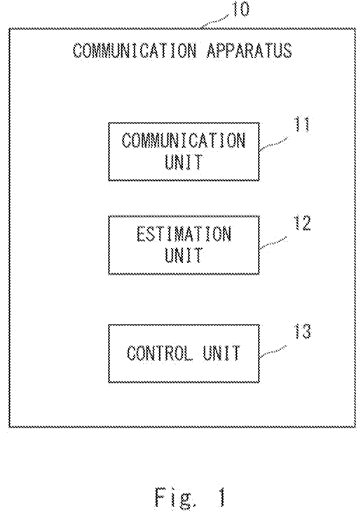

Hereinafter, a configuration example of a control apparatus 10 will be described with reference to FIG. 1. The control apparatus 10 may be a computer apparatus that operates when a processor executes programs stored in a memory.

The control apparatus 10 includes a communication unit 11, an estimation unit 12, and a control unit 13. The communication unit 11, the estimation unit 12, and the control unit 13 may be software or modules whose processing is performed by a processor executing programs stored in a memory. Alternatively, the communication unit 11, the estimation unit 12, and control unit 13 may be hardware, such as a circuit or chip.

The communication unit 11 communicates with a non-terrestrial communication apparatus and a terrestrial communication apparatus. The non-terrestrial communication apparatus is a communication apparatus constituting a Non Terrestrial Network (NTN) and may be a communication apparatus supporting satellite communication. Alternatively, the non-terrestrial communication apparatus may be an unmanned flight apparatus called a High Altitude Platform Station (HAPS).

The terrestrial communication apparatus may be, for example, a base station used for mobile communications. A radio access network is composed of an RRH (Remote Radio Head) that processes radio frequencies and a BBU (Baseband Unit) that performs baseband processing. The terrestrial communication apparatus may be a communication apparatus that performs processing including RRH and BBU, or may be a communication apparatus that performs processing only including RRH.

The estimation unit 12 estimates a delay time in the communication with the communication terminal through the non-terrestrial communication apparatus from the communication with the communication terminal through the terrestrial communication apparatus. The communication terminal may be, for example, a mobile phone terminal, a smartphone terminal, or an Internet of Things (IoT) terminal. Alternatively, the communication terminal may be a vehicle or the like having communication capabilities. Further alternatively, the communication terminal may be a fixed terminal that is not moved.

The delay time may be, for example, a time indicating a difference between the timing at which the communication terminal has received a signal or message through the terrestrial communication apparatus and the timing at which the communication terminal has received a signal or message through the non-terrestrial communication apparatus. The signals or messages received by the communication terminal with a time difference are signals or messages transmitted substantially simultaneously from the control apparatus 10 to the non-terrestrial communication apparatus and the terrestrial communication apparatus. Substantially simultaneous includes a case where a predetermined difference occurs between the timing at which a signal is transmitted to the non-terrestrial communication apparatus and the timing at which a signal is transmitted to the terrestrial communication apparatus. For example, the predetermined difference may include a time difference that is sufficiently short compared to the time it takes for a signal transmitted from the control apparatus 10 to arrive at the communication terminal through the non-terrestrial communication apparatus or the terrestrial communication apparatus.

For example, the estimation unit 12 may receive information indicating the delay time from the communication terminal. Alternatively, the estimation unit 12 may receive information indicating the delay time at the communication terminal from a measurement apparatus or the like that estimates the delay time at the communication terminal. The measurement apparatus may be, for example, a terrestrial communication apparatus.

The control unit 13 inserts reference signals into a first signal sequence to be transmitted to the non-terrestrial communication apparatus and a second signal sequence to be transmitted to the terrestrial communication apparatus. The reference signal is used in the communication terminal to estimate a state of a transmission line in a radio section, for example, quality of the transmission line.

Here, it is assumed that the communication terminal performs MIMO (Multiple Input Multiple Output) communication with the non-terrestrial communication apparatus and the terrestrial communication apparatus. The MIMO communication is a communication scheme in which a transmission apparatus and a reception apparatus communicate with each other using a plurality of antenna elements. For example, when a communication terminal is a reception apparatus, a communication system composed of a non-terrestrial communication apparatus and a terrestrial communication apparatus as a transmission apparatus can be regarded as a communication apparatus having a plurality of antenna elements. When a communication terminal is a transmission apparatus, a communication system composed of a non-terrestrial communication apparatus and a terrestrial communication apparatus as a reception apparatus can be regarded as a communication apparatus having a plurality of antenna elements. In other words, the control apparatus 10, the non-terrestrial communication apparatus, and the terrestrial communication apparatus are regarded as communication systems having the non-terrestrial communication apparatus and the terrestrial communication apparatus as antennas.

In the MIMO communication, for example, when the Scattered type MIMO communication is used, an apparatus on the transmitting end transmits reference signals from each antenna. At a given timing, only one antenna transmits reference signals, while the other antennas do not. In other words, at the receiving end, only the signals transmitted from a specific antenna at a specific timing have reference signals set, while signals transmitted from other antennas do not have reference signals set. Therefore, the control unit 13 controls the timing at which the reference signals are inserted into the first and second signal sequences using a delay time, so that the communication terminal does not receive the reference signals at substantially the same timing from both the non-terrestrial communication apparatus and the terrestrial communication apparatus. In other words, the control unit 13 controls the timing at which the reference signals are inserted into the first and second signal sequences using the delay time, so that the communication terminal receives the reference signals from either the non-terrestrial communication apparatus or the terrestrial communication apparatus within a predetermined period of time.

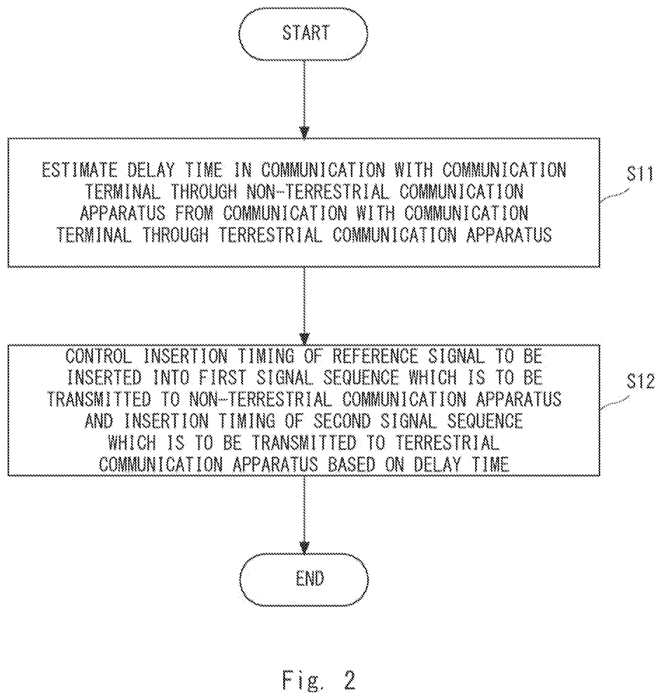

Next, a flow of communication processing executed by the control apparatus 10 will be described with reference to FIG. 2. First, the estimation unit 12 estimates the delay time in the communication with the communication terminal through the non-terrestrial communication apparatus from the communication with the communication terminal through the terrestrial communication apparatus (S11). Next, the control unit 13 controls an insertion timing of the reference signal to be inserted into the first signal sequence which is to be transmitted to the non-terrestrial communication apparatus and an insertion timing of the second signal sequence which is to be transmitted to the terrestrial communication apparatus based on the delay time (S12). Here, it is assumed that the communication terminal performs the MIMO communication with the terrestrial communication apparatus and the non-terrestrial communication apparatus.

As described above, the control apparatus 10 transmits the signal sequences in which the reference signals are inserted to the non-terrestrial communication apparatus and the terrestrial communication apparatus which perform the MIMO communication with the communication terminal. Furthermore, the control apparatus 10 controls the timings at which the reference signals are inserted into the signal sequence to be transmitted to the non-terrestrial communication apparatus and the terrestrial communication apparatus. Thus, the communication terminal can receive the reference signals set only in the signal transmitted from either the non-terrestrial communication apparatus or the terrestrial communication apparatus at the timing at which the signals are received. As a result, the communication terminal can estimate the state of the transmission line in a radio space between the non-terrestrial communication apparatus and the terrestrial communication apparatus performing the MIMO communication by using the reference signals, and thereby achieve the diversity effect of the MIMO communication.

An example of the effect of the present disclosure is to provide a control apparatus, a communication system, a control method, and a program capable of exhibiting the diversity effect in a hybrid mobile communication system using the terrestrial communication apparatus and the non-terrestrial communication apparatus.

### Second Example Embodiment

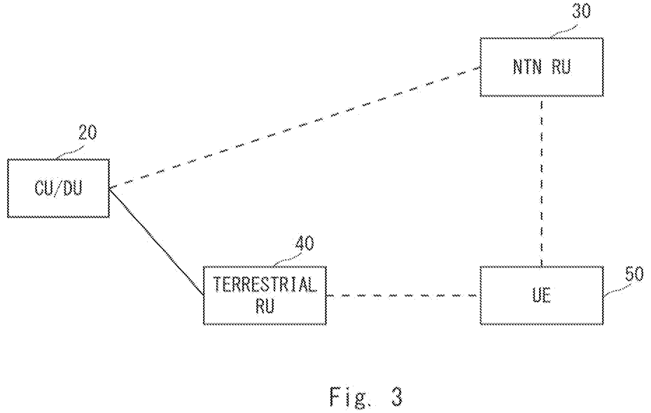

Next, a configuration example of the communication system will be described with reference to FIG. 3. The communication system of FIG. 3 includes a CU/DU (Centralized Unit/Distributed Unit) apparatus 20 (hereinafter referred to as a CU/DU 20), an NTN RU (Radio Unit) apparatus 30 (hereinafter referred to as an NTN RU 30), a terrestrial RU apparatus 40 (hereinafter referred to as a terrestrial RU 40), and a UE (User Equipment) 50.

Each of the CU/DU 20, the NTN RU 30, the terrestrial RU 40, and the UE 50 may be a computer apparatus that operates when a processor executes programs stored in a memory.

The CU/DU 20 has a BBU that performs non-radio frequency processing, i.e., baseband processing. Each of the NTN RU 30 and the terrestrial RU 40 has an RRH that performs processing related to radio frequencies. Although FIG. 3 shows one CU/DU 20, one NTN RU 30, and one terrestrial RU 40, for example, the CU/DU 20 may communicate with a plurality of NTN RUs and terrestrial RUs, including the NTN RU 30 and the terrestrial RU 40. In addition, the NTN RU 30 and the terrestrial RU 40 may communicate with a plurality of UEs 50. Further, the NTN RU 30 and the terrestrial RU 40 may communicate with a plurality of CUs/DUs including the CU/DU 20.

The dashed lines in FIG. 3 indicate that wireless communication is performed. The solid line in FIG. 3 indicates that fixed communication is mainly performed, but wireless communication may also be performed in the section indicated by the solid line.

The NTN RU 30 may be a communication satellite or a HAPS which is an unmanned flight apparatus. The NTN RU 30 is an apparatus which can form a communication area larger than a communication area formed by a base station apparatus installed on the ground in a space that is not constrained by geographical limitations when the communication area is formed. The communication area formed by the NTN RU 30 is not limited to the ground, and may be extended to the sky, sea, outer space, and other areas. The NTN RU 30 performs wireless communication with the CU/DU 20 and the UE 50. The NTN RU 30 also performs wireless communication with the terrestrial RU 40. The frequency band used for the wireless communication between the CU/DU 20 and the NTN RU 30 may be different from the frequency band used for the wireless communication between the NTN RU 30 and the UE 50. The frequency band used for the wireless communication between the terrestrial RU 40 and the NTN RU 30 may be the same as or different from the frequency band used for the wireless communication between the NTN RU 30 and the UE 50.

The terrestrial RU 40 is an apparatus placed on the ground and may be a base station apparatus including an RRH. The terrestrial RU 40 may perform wireless communication with the CU/DU 20 and may perform fixed communication such as optical communication. The terrestrial RU 40 may, for example, support 5G, a wireless communication standard defined by the 3rd Generation Partnership Project (3GPP). 5G may be referred to as NR. The terrestrial RU 40 may use UE 50 and 5G for wireless communication.

The term UE 50 is used as a generic term for a communication terminal in 3GPP. The UE 50 has a plurality of antennas and performs the MIMO communication with the NTN RU 30 and the terrestrial RU 40. When the UE 50 is a reception apparatus, the communication system including the CU/DU 20, the NTN RU 30, and the terrestrial RU 40 is regarded as a transmission apparatus with a plurality of antennas. When the UE 50 is a transmission apparatus, the communication system including the CU/DU 20, the NTN RU 30, and the terrestrial RU 40 is regarded as a reception apparatus with a plurality of antennas.

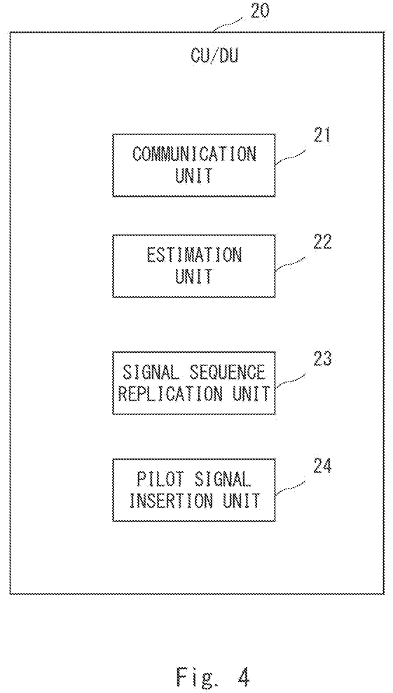

Next, a configuration example of the CU/DU 20 will be described with reference to FIG. 4. The CU/DU 20 includes a communication unit 21, an estimation unit 22, a signal sequence replication unit 23, and a pilot signal insertion unit 24. The communication unit 21, the estimation unit 22, the signal sequence replication unit 23, and the pilot signal insertion unit 24 may be software or modules whose processing is performed by a processor executing programs stored in a memory. Alternatively, the communication unit 21, the estimation unit 22, the signal sequence replication unit 23, and the pilot signal insertion unit 24 may be hardware such as a circuit or chip.

The communication unit 21 corresponds to the communication unit 11 in FIG. 1. The estimation unit 22 corresponds to the estimation unit 12 in FIG. 1. The signal sequence replication unit 23 and the pilot signal insertion unit 24 correspond to the control unit 13 in FIG. 1.

The communication unit 21 communicates with the NTN RU 30 and the terrestrial RU 40. The communication unit 21 communicates wirelessly with the NTN RU 30 and may also communicate with the terrestrial RU 40 via a cable or the like. Alternatively, the communication unit 11 may communicate wirelessly with the NTN RU 30 and the terrestrial RU 40. The communication unit 11 may have a communication control unit for communicating with the NTN RU 30 and a communication control unit for communicating with the terrestrial RU 40. The communication control unit may, for example, perform modulation, demodulation, encoding, and so on.

The estimation unit 22 estimates a difference between a time taken for data transmitted to the NTN RU 30 and a time taken for the data transmitted to the terrestrial RU 40 at substantially the same time to arrive at the UE 50. In other words, when the two pieces of data transmitted at substantially the same timing arrive at the UE 50, the estimation unit 22 estimates the delay time between the arrival of one piece of data and the arrival of the other piece of data. Here, the communication path through the NTN RU 30 is longer than the communication path through the terrestrial RU 40. Therefore, the data arriving at the UE 50 through the NTN RU 30 is delayed from the data arriving at the UE 50 through the terrestrial RU 40.

The estimation unit 22 receives the measurement result of the delay time from the terrestrial RU 40, and may estimate the received delay time as the delay time when two pieces of data transmitted at substantially the same timing arrive at the UE 50. For example, the terrestrial RU 40 may measure the time from when a signal for measurement is transmitted to the NTN RU 30 until when a response signal is received from the NTN RU 30.

Alternatively, if the terrestrial RU 40 is installed indoors and the terrestrial RU 40 cannot receive the signal for measurement transmitted from the NTN RU 30, the estimation unit 22 may receive the measurement result of the delay time from the terrestrial RU installed outdoors.

The estimation unit 22 may estimate the measured time as the delay time when two pieces of data transmitted at substantially the same timing arrive at the UE 50. Here, it is assumed that the length of the communication path from the CU/DU 20 to the UE 50 through the terrestrial RU 40 is sufficiently shorter than the length of the communication path from the CU/DU 20 to the UE 50 through the NTN RU 30. Sufficiently short may refer to being short enough to be negligible.

Alternatively, the estimation unit 22 may have trajectory information about the NTN RU 30. In this case, the estimation unit 22 may calculate the distance between the NTN RU 30 and the ground surface at a certain time according to the trajectory information. The estimation unit 22 may estimate two times the distance between the NTN RU 30 and the ground surface as the distance from the CU/DU 20 to the UE 50 through the NTN RU 30 to calculate the propagation time of the data propagating over the distance two times the distance between the NTN RU 30 and the ground surface. The estimation unit 22 may consider the distance between the CU/DU 20 and UE 50 through the terrestrial RU 40 to be short enough to be negligible and estimate the calculated propagation time as the delay time when the two pieces of data transmitted at substantially the same timing arrive at the UE 50.

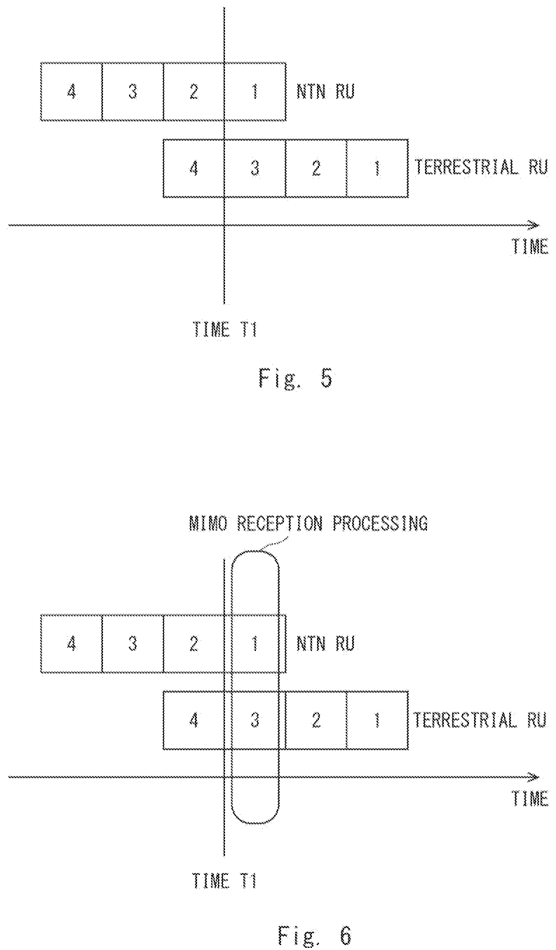

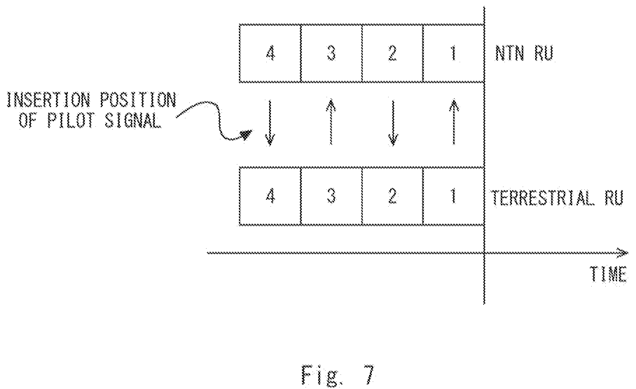

FIG. 5 shows a signal sequence received by the UE 50 through the NTN RU 30 and a signal sequence received by the UE 50 through the terrestrial RU 40. FIG. 5 shows that a plurality of frames are used as data constituting each signal sequence. In FIG. 5, numbers constituting each signal sequence indicate identification numbers of frames. The CU/DU 20 transmits a signal sequence starting with the frame #1 to the NTN RU 30 and the terrestrial RU 40 at substantially the same timing. FIG. 5 shows that the signal sequence propagated through the terrestrial RU 40 has arrived at the UE 50 earlier than the signal sequence propagated through the NTN RU 30. Specifically, the signal sequence propagated through the terrestrial RU 40 arrived at the UE 50 two frames earlier than the signal sequence propagated through the NTN RU 30. The horizontal axis in FIG. 5 represents time. The further to the right on the horizontal axis a reception time of a frame is, the later the reception time becomes. The same applies to FIG. 6. The UE 50 receives the signal sequences sequentially from the frame #1.

In FIG. 5, the UE 50 receives the frame #3 through the terrestrial RU 40 and the frame #1 through the NTN RU 30 at the time T1.

The estimation unit 22 may estimate the delay time in the unit of a frame. For example, in the example of FIG. 5, the estimation unit 22 may estimate that the delay time when two pieces of data transmitted at substantially the same timing arrive at the UE 50 is two frames. The length of the frames may be predetermined, for example, 1 ms or 0.5 ms.

Returning to FIG. 4, the signal sequence replication unit 23 replicates the signal sequence, which is the data to be transmitted in order to transmit the data to the NTN RU 30 and the terrestrial RU 40 through the communication unit 21. After the signal sequences are replicated, the signal sequence replication unit 23 outputs, to the pilot signal insertion unit 24, the signal sequence for transmission to the NTN RU 30 and the signal sequence for transmission to the terrestrial RU 40. The signal sequence for transmission to the NTN RU 30 is the same signal sequence as the signal sequence for transmission to the terrestrial RU 40. The same signal sequence is a signal sequence having the same configuration of the frames.

The pilot signal insertion unit 24 inserts pilot signals into the signal sequence for transmission to the NTN RU 30 and the signal sequence for transmission to the terrestrial RU 40. The pilot signal corresponds to a reference signal. The pilot signal may also be referred to as a known signal. For example, the pilot signal may be a signal set in a preamble that is placed at the beginning of each frame constituting the signal sequence or set at the beginning of a packet included in the frame.

The pilot signal is used by the UE 50 to separate the signal sequences transmitted from the NTN RU 30 and the terrestrial RU 40 to the UE 50. Specifically, the pilot signal is used to estimate each of elements constituting the channel matrix for a space between the NTN RU 30 and the terrestrial RU 40 and the UE 50. The estimation may refer to identifying or determining these elements. For example, if the UE 50 has two antennas, the signals transmitted from the NTN RU 30 and the terrestrial RU 40 to the UE 50 are represented using a 2×2 channel matrix. The UE 50 estimates the channel matrix using the pilot signals received from each of the NTN RU 30 and the terrestrial RU 40. The UE 50 uses the estimated channel matrix to separate the data received at each antenna to obtain the signal sequence received from the NTN RU 30 and the signal sequence received from the terrestrial RU 40. The channel matrix may be referred to as a transmission coefficient matrix, transmission function, or the like.

In Scattered-type MIMO communication, if an apparatus on a transmitting end includes a plurality of antennas, at the timing when a pilot signal is transmitted from one antenna, no pilot signal is transmitted from the other antennas. However, in the communication system shown in FIG. 3, the distance between the CU/DU 20 and the NTN RU 30 (considered as an antenna) and the distance between the CU/DU 20 and the terrestrial RU 40 (also considered as an antenna) are significantly apart. Therefore, the timing at which the signal sequences transmitted from the CU/DU to the NTN RU 30 and the terrestrial RU 40 at essentially the same timing arrive at the NTN RU 30 is delayed from the timing at which they arrive at the terrestrial RU 40.

When the Scattered-type MIMO communication is applied to the communication system of FIG. 3, the pilot signal insertion unit 24 inserts the pilot signals into one of the frames transmitted from the CU/DU 20 to the NTN RU 30 and the terrestrial RU 40 at substantially the same timing. For example, a case will be described in which the frame #1 is transmitted from the CU/DU 20 to the NTN RU 30 and the terrestrial RU 40 at substantially the same timing. In such a case, when the pilot signals are inserted into the frame #1 to be transmitted to the NTN RU 30, the pilot signal insertion unit 24 does not insert pilot signals into the frame #1 to be transmitted to the terrestrial RU 40. In other frames, the pilot signal insertion unit 24 may insert pilot signals into the frame to be transmitted to the terrestrial RU 40 without inserting pilot signals into the frame to be transmitted to the NTN RU 30.

Furthermore, the pilot signal insertion unit 24 controls the frame in which the pilot signals are to be inserted using the delay time estimated by the estimation unit 22. Controlling may refer to adjusting, selecting, determining, etc.

The pilot signal insertion unit 24 sets the state in which the pilot signals are inserted only in the frame included in one of the signal sequences at a predetermined timing when the UE 50 receives the signal sequences from the NTN RU 30 and the terrestrial RU 40.

Here, the insertion of the pilot signals by the pilot signal insertion unit 24 will be described in more detail with reference to FIG. 6. FIG. 6, similar to FIG. 5, shows that the UE 50 receives the frames transmitted through the NTN RU 30 with a delay of two frames from the frames transmitted through the terrestrial RU 40 at substantially the same timing from the CU/DU 20. As shown in FIG. 6, the UE 50 receives the frame #1 from the NTN RU 30 and the frame #3 from the terrestrial RU 40 at time T1. In this case, the pilot signal insertion unit 24 controls the insertion of pilot signals into either the frame #1 through the NTN RU 30 and the frame #3 through the terrestrial RU 40, which are received by the UE 50 at substantially the same timing at time T1.

The UE 50 performs MIMO reception processing using the received pilot signal. Specifically, the UE 50 estimates the channel matrix using the received pilot signal. Furthermore, the UE 50 separates the frame #1 received from the NTN RU 30 and the frame #3 received from the terrestrial RU 40 using the estimated channel matrix.

Here, the insertion of the pilot signals by the pilot signal insertion unit 24 will be described with reference to FIG. 7. The horizontal axis in FIG. 7 represents time. The further to the right on the horizontal axis a transmission time of a signal sequence is, the later the transmission time becomes. The further to the right on the horizontal axis a reception time of a frame is, the later the reception time becomes. As shown in FIG. 7, the signal sequences transmitted from the CU/DU 20 to the NTN RU 30 and the terrestrial RU 40 are transmitted at substantially the same timing. Arrows directed to respective frames in FIG. 7 indicate frames into which the pilot signal insertion unit 24 inserts the pilot signals. For example, the pilot signal insertion unit 24 inserts the pilot signals into the frames #1 and #3 included in the signal sequence to be transmitted to the NTN RU 30. Furthermore, the pilot signal insertion unit 24 inserts the pilot signals into the frames #2 and #4 included in the signal sequence to be transmitted to the terrestrial RU 40.

That is, the pilot signal insertion unit 24 determines the signal sequence into which the pilot signals are inserted in the same pattern as n frames earlier when the delay time is n (n is a positive integer) frames. Specifically, when the delay time is two frames, the pilot signal insertion unit 24 inserts pilot signals into the frame #3 in the same manner as it inserts the pilot signals into the frame #1, which has been transmitted two frames earlier, into the signal sequence to be transmitted to the NTN RU 30. When the pilot signal is inserted into the frame #4, the pilot signal insertion unit 24 inserts the pilot signals into the signal sequence to be transmitted to the terrestrial RU 40 in the same manner as it inserts the pilot signals into the frame #2 two frames earlier.

Here, when the communication unit 21 transmits the signal sequences to the NTN RU 30 and the terrestrial RU 40 at substantially the same timing, the starting position of the frame included in the signal sequence received by the UE 50 from the NTN RU 30 may be shifted from the starting position of the frame included in the signal sequence received by the UE 50 from the terrestrial RU 40. The shift of the starting position of the frames may be, for example, shorter than the one frame time and longer than the cyclic prefix time in the OFDM symbol. If such a shift occurs, the UE 50 may not be able to successfully separate frames received from each of the NTN RU 30 and terrestrial RU 40. Therefore, the communication unit 21 may shift the timing of signals transmitted to either the NTN RU 30 or the terrestrial RU 40 from the timing of signals transmitted to the other so that the starting position of frames included in the signal sequence received by the UE 50 is not shifted. For example, the CU/DU 20 may receive information about the shift of the starting position of frames from the UE 50 as feedback information. Alternatively, the NTN RU 30 or the terrestrial RU 40 may receive feedback information from the UE 50, and the communication unit of the NTN RU 30 or the terrestrial RU 40 may intentionally delay the timing at which the signal sequence received from the CU/DU 20 is to be transmitted to the UE 50.

By inserting the pilot signals as shown in FIG. 7, when the UE 50 receives the signal sequences from the NTN RU 30 and the terrestrial RU 40, the pilot signals are inserted into only one of the two frames that will be received at substantially the same timing.

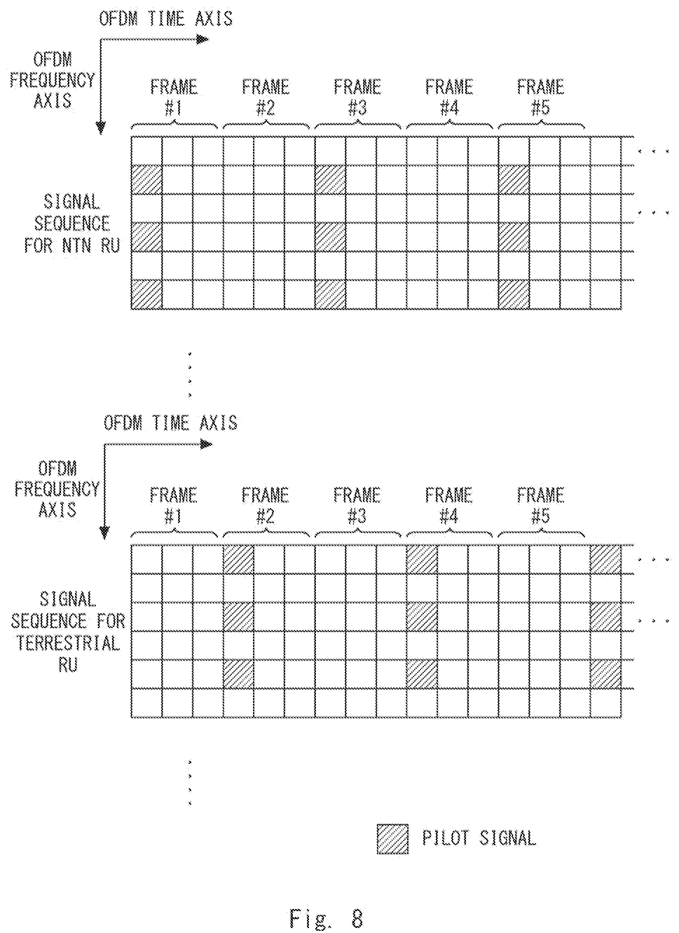

An example of the arrangement of the pilot signal in the OFDM signal will be described with reference to FIG. 8. FIG. 8 shows radio resources determined by time and frequency. Time may be indicated using symbols. That is, the radio resources in the OFDM signal may be defined by symbols and frequencies. It is also shown that one frame has three symbols. The number of symbols constituting one frame is not limited to three symbols and may take various values.

FIG. 8 shows that pilot signals are inserted into the radio resources that are shaded. For example, FIG. 8 shows that the pilot signals are inserted into the starting symbols of the radio resources assigned to frames #1, #3, and #5 among frames transmitted through the NTN RU 30. It is also shown that the pilot signals are inserted into the starting symbols of the radio resources assigned to frames #2 and #4 among frames transmitted through the terrestrial RU 40. The positions where the pilot signals are inserted and the number of pilot signals are not limited to the example shown in FIG. 8.

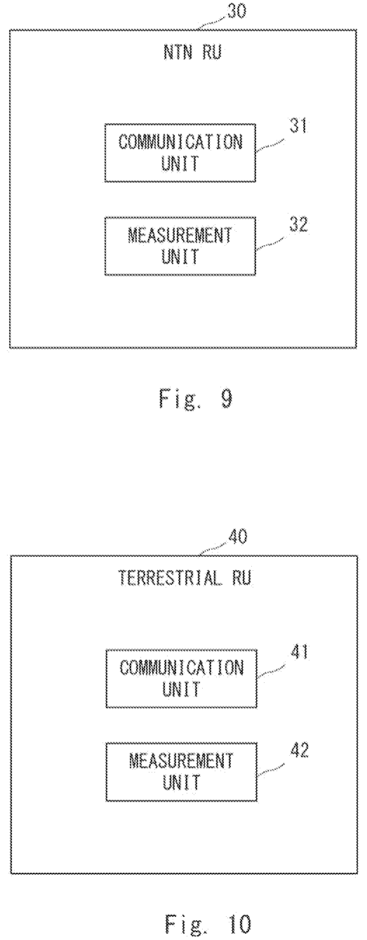

Next, a configuration example of the NTN RU 30 will be described with reference to FIG. 9. The NTN RU 30 has a communication unit 31 and a measurement unit 32. The communication unit 31 and the measurement unit 32 may be software or modules whose processing is performed by a processor executing programs stored in a memory. Alternatively, the communication unit 31 and the measurement unit 32 may be hardware such as circuits or chips.

The communication unit 31 performs wireless communication with the CU/DU 20, the terrestrial RU 40, and the UE 50. The communication unit 31 may have a communication control unit for communication with the CU/DU 20, a communication control unit for communication with the terrestrial RU 40, and a communication control unit for communication with the UE 50. When the communication unit 31 performs wireless communication with the CU/DU 20, the terrestrial RU 40, and the UE 50, it may use either the same frequency band for all of them or different frequency bands for each of them. Alternatively, the communication unit 31 may separate the frequency band when performing wireless communication with the CU/DU 20 from the frequency band when performing wireless communication with the terrestrial RU 40 and the UE 50.

The communication unit 31 transmits the signal sequence received from the CU/DU 20 to the UE 50. The measurement unit 32 transmits a measurement signal used to measure the delay time generated in the UE 50 to the terrestrial RU 40. When the measurement unit 32 receives a request signal for requesting the transmission of the measurement signal from the terrestrial RU 40, it may transmit the measurement signal to the terrestrial RU 40 in response to the request signal. That is, the measurement signal may be a response signal to the request signal received from the terrestrial RU 40. Alternatively, the measurement unit 32 may transmit the request signal to the terrestrial RU 40 regardless of whether the requested signal is received from the terrestrial RU 40.

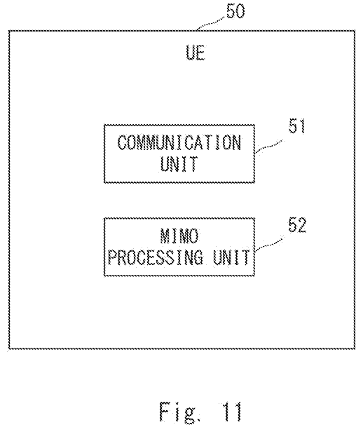

Next, a configuration example of the terrestrial RU 40 will be described with reference to FIG. 10. The terrestrial RU 40 has a communication unit 41 and a measurement unit 42. The communication unit 41 and the measurement unit 42 may be software or modules whose processing is performed by a processor executing programs stored in a memory. Alternatively, the communication unit 41 and the measurement unit 42 may be hardware such as circuits or chips.

The communication unit 41 performs wireless communication with the CU/DU 20, the NTN RU 30, and the UE 50. The communication unit 41 may have a communication control unit for communication with the CU/DU 20, a communication control unit for communication with the NTN RU 30, and a communication control unit for communication with the UE 50. When the communication unit 41 performs wireless communication with the CU/DU 20, the NTN RU 30, and the UE 50, it may use either the same frequency band for all of them or different frequency bands for each of them. Alternatively, the communication unit 41 may separate the frequency band when performing wireless communication with the CU/DU 20 from the frequency band when performing wireless communication with the NTN RU 30 and the UE 50.

The communication unit 41 transmits the signal sequence received from the CU/DU 20 to the UE 50. The measurement unit 42 measures the delay time generated in the UE 50. For example, the measurement unit 42 transmits a request signal for requesting the transmission of a measurement signal to the NTN RU 30 through the communication unit 41. After that, the measurement unit 42 receives the measurement signal through the communication unit 41 as a response signal to the request signal.

The measurement unit 42 may estimate the time from the transmission of the request signal to the reception of the measurement signal as the delay time. Alternatively, when the measurement signal is received without transmitting the request signal, the measurement unit 42 may calculate a propagation time of the measurement signal from the NTN RU 30 to the terrestrial RU 40 using, for example, information included in the measurement signal indicating the time at which the NTN RU 30 has transmitted the measurement signal. In this case, the measurement unit 42 may estimate the time obtained by doubling the calculated propagation time as the delay time. The measurement unit 42 transmits the estimated delay time to the CU/DU 20 through the communication unit 41.

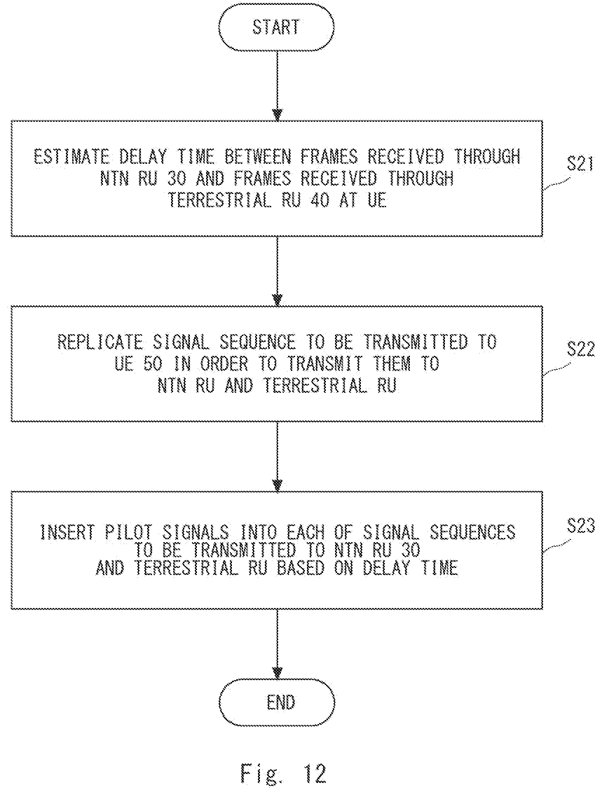

Next, a configuration example of the UE 50 will be described with reference to FIG. 11. The UE 50 includes a communication unit 51 and a MIMO processing unit 52. The communication unit 51 and the MIMO processing unit 52 may be software or modules whose processing is performed by a processor executing programs stored in a memory. Alternatively, the communication unit 51 and the MIMO processing unit 52 may be hardware such as circuits or chips.

The communication unit 51 receives a signal sequence from each of the NTN RU 30 and the terrestrial RU 40. For example, the communication unit 51 has two antennas and receives the signal sequences transmitted from the NTN RU and the terrestrial RU 40 at the respective antennas. That is, the communication unit 51 receives the signal sequences transmitted from the NTN RU 30 and the terrestrial RU 40 at one antenna and also receives the signal sequences transmitted from the NTN RU 30 and the terrestrial RU 40 at the other antenna.

Receiving a signal sequence may refer to receiving frames included in the signal sequence. For example, suppose that the communication unit 51 receives the frame #1 from the NTN RU 30 and the frame #3 from the terrestrial RU 40 at time T1, as shown in FIG. 6.

The MIMO processing unit 52 estimates the channel matrix using the pilot signals inserted in either the frame #1 or the frame #3. For example, when the CU/DU 20 inserts the pilot signals as shown in FIG. 7, the channel matrix is estimated using the pilot signals inserted in the frame #1 received from the NTN RU 30.

Further, the MIMO processing unit 52 uses the estimated channel matrix to separate the data received by each antenna to obtain the frame #1 and frame #3.

Next, a flow of the communication processing in the CU/DU 20 will be described with reference to FIG. 12. First, the estimation unit 22 estimates the delay time between the frames received through the NTN RU 30 and the frames received through the terrestrial RU 40 at the UE 50 (S21). The estimation unit 22 may estimate the delay time occurring at the UE 50 using delay information received from the terrestrial RU 40. Alternatively, the estimation unit 22 may calculate the delay time occurring at the UE 50 using the trajectory information about the NTN RU 30.

Next, the signal sequence replication unit 23 replicates the signal sequence to be transmitted to the UE 50 (S22). The signal sequence replication unit 23 replicates the signal sequence to generate the same number of signal sequences as the paths when the signal sequences are transmitted to the UE 50.

Next, the pilot signal insertion unit 24 inserts the pilot signals into each of the signal sequences to be transmitted to the NTN RU 30 and the terrestrial RU (S23). The pilot signal insertion unit 24 determines a difference in frames that occurs when frames transmitted from the CU/DU 20 at substantially the same timing arrive at the UE 50, based on the delay time. For frames that will be received at substantially the same timing by the UE 50, the pilot signal insertion unit 24 selects a frame to which the pilot signal is to be transmitted so as to insert the pilot signal into the frame. The frames into which the pilot signals are inserted and frames into which the pilot signals are not inserted are transmitted to the UE 50 through the NTN RU 30 and the terrestrial RU 40.

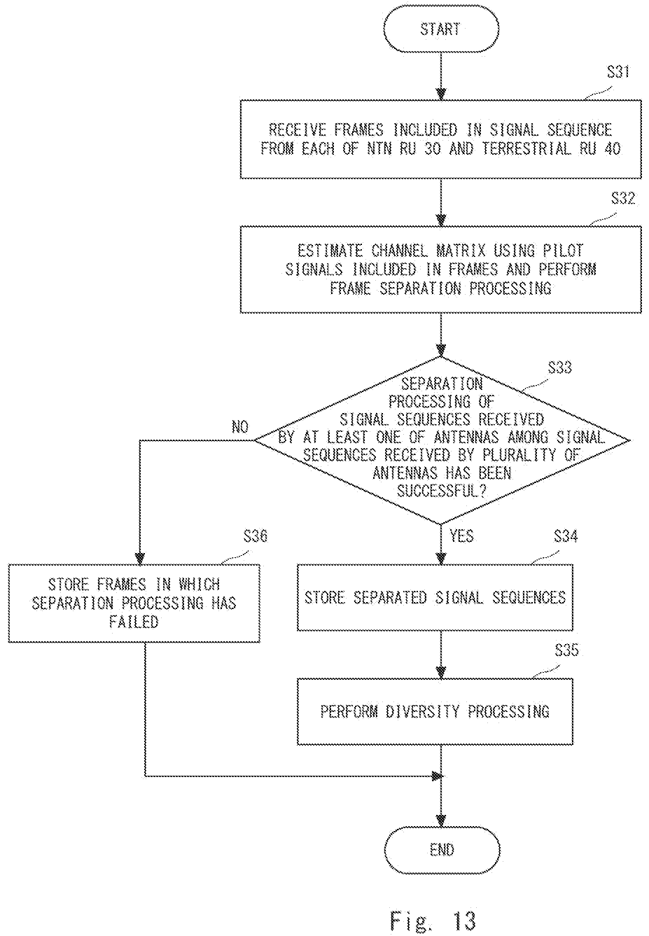

Next, a flow of signal reception processing in the UE 50 will be described with reference to FIG. 13. First, the communication unit 51 receives frames included in the signal sequence from each of the NTN RU 30 and the terrestrial RU 40 (S31). Next, the MIMO processing unit 52 estimates the channel matrix using the pilot signals included in the frames and performs frame separation processing (S32).

Next, the MIMO processing unit 52 determines whether or not the separation processing of the signals received by at least one of the antennas among the signals received by the plurality of antennas, for example, the two antennas, has been successful (S33). For example, the MIMO processing unit 52 may perform a CRC check on the signals after the separation processing and determine that the separation processing has been successful when no error occurs or determine that the separation processing has been unsuccessful when an error occurs.

If the separation processing of the signals is successful, the MIMO processing unit 52 stores the separated signals (S34). Next, the MIMO processing unit 52 performs diversity processing on the received signals, corrects the signals, and performs other processing (S35). For example, the MIMO processing unit 52 may perform the diversity processing using the same signals received by the plurality of antennas. Alternatively, when the same signal as the received signal has already been stored, the MIMO processing unit 52 may perform the diversity processing using the received signal and the stored signal. The MIMO processing unit 52 may perform the diversity processing between the signal stored as a signal that does not include an error and the signal stored as a signal including an error. If the same signal as the received signal is not present, the MIMO processing unit 52 may terminate signal reception processing without performing the diversity processing.

If the MIMO processing unit 52 determines that the signal separation processing in all antennas has failed, it stores the frames in which the separation processing has failed (S36).

As explained above, the CU/DU 20 estimates how much delay occurs when signal sequences transmitted at substantially the same timing arrive at the UE 50. Furthermore, the CU/DU 20 uses the estimated delay time to select frames into which the pilot signals are inserted, ensuring that the pilot signals are not inserted into both frames received by the UE 50 through the NTN RU 30 and the terrestrial RU 40. This allows the UE 50 to separately receive the signal sequences from the NTN RU 30 and the terrestrial RU 40 when performing the MIMO communication with the NTN RU 30 and the terrestrial RU 40. As a result, the UE 50 can achieve the diversity effect of performing the MIMO communication, and thus can prevent degradation of signal quality in the radio section.

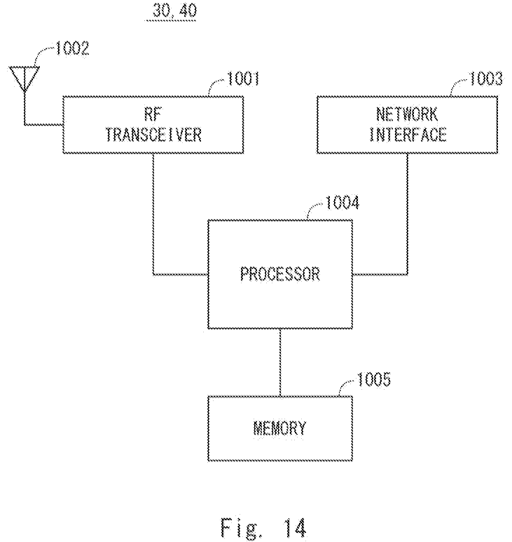

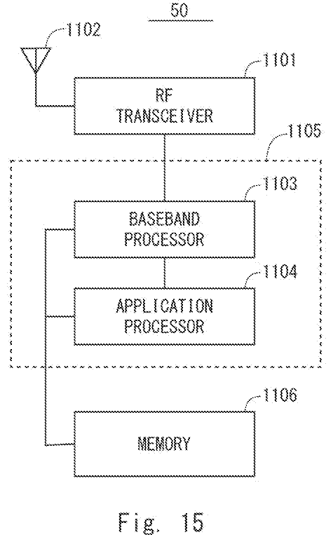

FIG. 14 is a block diagram showing a configuration example of the NTN RU 30 and the terrestrial RU 40 (hereinafter referred to as the NTN RU 30, etc.). Referring to FIG. 14, each of the NTN RU 30, etc. includes an RF transceiver 1001, a network interface 1003, a processor 1004, and a memory 1005. The RF transceiver 1001 performs analog RF signal processing to communicate with the UEs. The RF transceiver 1001 may include a plurality of transceivers. The RF transceiver 1001 is coupled to an antenna 1002 and the processor 1004. The RF transceiver 1001 receives modulated symbol data (or OFDM symbol data) from the processor 1004, generates a transmitted RF signal, and supplies the transmitted RF signal to antenna 1002. The RF transceiver 1001 also generates a baseband received signal based on the received RF signal received by the antenna 1002 and supplies it to the processor 1004.

The network interface 1003 is used to communicate with network nodes (e.g., other core network nodes). The network interface 1003 may include, for example, an IEEE 802.3 series compliant network interface card (NIC).

The processor 1004 performs data plane and control plane processing, including digital baseband signal processing for wireless communications. The digital baseband signal processing may be performed in other communication apparatuses.

The processor 1004 may include a plurality of processors. For example, the processor 1004 may include a modem processor (e.g., DSP) for digital baseband signal processing and a protocol stack processor (e.g., CPU or MPU) for control plane processing.

The memory 1005 is composed of a combination of a volatile memory and a non-volatile memory. The memory 1005 may include a plurality of physically independent memory devices. The volatile memory is, for example, a Static Random Access Memory (SRAM), a Dynamic RAM (DRAM), or a combination thereof. The non-volatile memory may be a Mask Read Only Memory (MROM), an Electrically Erasable Programmable ROM (EEPROM), a flash memory, or a hard disk drive, or any combination thereof. The memory 1005 may include a storage disposed separately from the processor 1004. In this case, the processor 1004 may access the memory 1005 through the network interface 1003 or an I/O interface not shown.

The memory 1005 may store one or more software modules (computer programs) including instructions and data for performing processing by the NTN RU 30 and the like described in the above example embodiments. In some implementations, the processor 1004 may be configured to read and execute the software module(s) from the memory 1005 to perform the processing of the base station 10 and the like described in the above example embodiments.

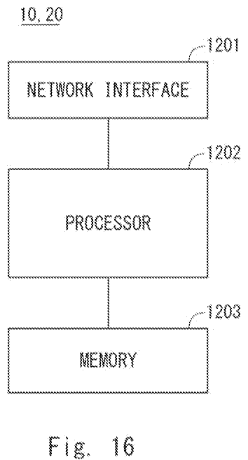

FIG. 15 is a block diagram showing a configuration example of the UE 50. The radio frequency (RF) transceiver 1101 performs analog RF signal processing to communicate with the NTN RU 30 and the terrestrial RU 40. The analog RF signal processing performed by the RF transceiver 1101 includes frequency upconversion, frequency downconversion, and amplification. The RF transceiver 1101 is coupled to the antenna 1102 and the baseband processor 1103. In other words, the RF transceiver 1101 receives modulation symbol data (or OFDM symbol data) from the baseband processor 1103, generates a transmission RF signal, and supplies the transmission RF signal to the antenna 1102. The RF transceiver 1101 generates a baseband reception signal based on the reception RF signal received by the antenna 1102 and supplies the baseband reception signal to the baseband processor 1103.

The baseband processor 1103 performs digital baseband signal processing (data plane processing) and control plane processing for wireless communication. The digital baseband signal processing includes (a) data compression/decompression, (b) data segmentation/concatenation, (c) transmission format (transmission frame) composition/decomposition, (d) channel encoding/decoding, (e) modulation (i.e., symbol mapping)/demodulation, and (f) Inverse Fast Fourier Transform (IFFT) generation of OFDM symbol data (baseband OFDM signal). On the other hand, the control plane processing includes communication management of the layers 1, 2, and 3.

The baseband processor 1103 may include a modem processor (e.g., Digital Signal Processor (DSP)) for digital baseband signal processing and a protocol stack processor (e.g., Central Processing Unit (CPU), or Micro Processing Unit (MPU)) for control plane processing. In this case, the protocol stack processor for control plane processing may be common to an application processor 1104 described later.

The application processor 1104 is also referred to as a CPU, MPU, microprocessor, or processor core. The application processor 1104 may include a plurality of processors (a plurality of processor cores). The application processor 1104 implements various functions of the UE 50 by executing system software programs (Operating System (OS)) and various application programs (e.g., call application, web browser, mailer, camera operation application, and music playback application) read from the memory 1106 or a memory not shown.

In some implementations, the baseband processor 1103 and the application processor 1104 may be integrated on one chip, as shown by dashed lines (1105) in FIG. 15. In other words, the baseband processor 1103 and the application processor 1104 may be implemented as one System on Chip (SoC) device 1105. The SoC device may also be referred to as a System Large Scale Integration (LSI) or chipset.

The memory 1106 is a volatile memory or a non-volatile memory or a combination thereof. The memory 1106 may include a plurality of physically independent memory devices. The volatile memory is, for example, Static Random Access Memory (SRAM), Dynamic RAM (DRAM) or a combination thereof. The non-volatile memory may be Mask Read Only Memory (MROM), an Electrically Erasable Programmable ROM (EEPROM), a flash memory, a hard disk drive, or any combination thereof. The memory 1106 may include, for example, an external memory device that can be accessed from the baseband processor 1103, the application processor 1104, or the SoC 1105. The memory 1106 may include an internal memory device integrated within the baseband processor 1103, the application processor 1104, or the SoC 1105. Further, the memory 1106 may include a memory in a Universal Integrated Circuit Card (UICC).

The memory 1106 may store software modules (computer programs) including instructions and data for processing by the UE 50 described in the above embodiments. In some implementations, the baseband processor 1103 or the application processor 1104 may load the software module(s) from the memory 1106 and execute the loaded software module(s), thereby performing the processing of the UE 50 described in the above embodiments with reference to the drawings.

FIG. 16 is a block diagram showing an example configuration of the control apparatus 10 and the CU/DU 20 (hereinafter referred to as the control apparatus 10, etc.). Referring to FIG. 16, each of the control apparatus 10, etc. includes a network interface 1201, a processor 1202, and a memory 1203. The network interface 1201 is used to communicate with network nodes (e.g., eNB, MME, P-GW). The network interface 1201 may include, for example, a Network Interface Card (NIC) that is compliant with IEEE 802.3 series. Here, eNB represents evolved Node B, MME represents Mobility Management Entity, and P-GW represents Packet Data Network Gateway. IEEE represents Institute of Electrical and Electronics Engineers.

The processor 1202 reads and executes software (computer programs) from the memory 1203 to perform processing such as the control apparatus 10 described using the flowchart in the example embodiments described above. The processor 1202 may be, for example, a microprocessor, MPU, or CPU. The processor 1202 may include a plurality of processors.

The memory 1203 is composed of a combination of a volatile memory and a non-volatile memory. The memory 1203 may include a storage disposed separately from the processor 1202. In this case, the processor 1202 may access the memory 1203 through an I/O (Input/Output) interface not shown.

In the example of FIG. 16, the memory 1203 is used to store software modules. The processor 1202 can read and execute these software modules from the memory 1203 to perform processing such as the control apparatus 10 described in the above example embodiments.

As described with reference to FIG. 16, each of the processors included in the control apparatus 10 or the like in the above example embodiments executes one or more programs including instructions for causing the computer to perform the operations and processing described in the above example embodiments.

In the above example, the program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### (Supplementary Note 1)

A control apparatus comprising:
a communication unit configured to communicate with a non-terrestrial communication apparatus and a terrestrial communication apparatus;
an estimation unit configured to estimate a delay time of communication with a communication terminal through the non-terrestrial communication apparatus from communication with the communication terminal through the terrestrial communication apparatus; and
a control unit configured to, when MIMO communication is performed with the communication terminal using the non-terrestrial communication apparatus and the terrestrial communication apparatus, control an insertion timing of reference signals to be inserted into a first signal sequence transmitted to the non-terrestrial communication apparatus and a second signal sequence transmitted to the terrestrial communication apparatus, based on the delay time.

### (Supplementary Note 2)

The control apparatus according to supplementary note 1, wherein at a timing when the control unit inserts the reference signals into one of the first signal sequence and the second signal sequence and transmits the one of the first signal sequence and the second signal sequence, the control unit does not insert the reference signals into another one of the first signal sequence and the second signal sequence.

### (Supplementary Note 3)

The control apparatus according to supplementary note 2, wherein the control unit identifies, based on the delay time, first data included in the first signal sequence and second data included in the second signal sequence to be received by the communication terminal at substantially the same timing, and inserts the reference signals into either of the first data and the second data.

### (Supplementary Note 4)

The control apparatus according to supplementary note 2 or 3, wherein
each of the first signal sequence and the second signal sequence is composed of a plurality of frames, and
the control unit switches a signal sequence into which the reference signals are inserted by a unit of the frame.

### (Supplementary Note 5)

The control apparatus according to any one of claims 2 to 4, wherein
the first signal sequence and the second signal sequence are signal sequences having communication resources in a time axis direction, and
the control unit alternately arranges the reference signals to be transmitted to the non-terrestrial communication apparatus and the reference signals to be transmitted to the terrestrial communication apparatus in the time axis direction.

### (Supplementary Note 6)

The control apparatus according to any one of supplementary notes 1 to 5, wherein
each of the first signal sequence and the second signal sequence is composed of a plurality of frames, and
the control unit controls a timing at which the first signal sequence is transmitted to the non-terrestrial communication apparatus and a timing at which the second signal sequence is transmitted to the terrestrial communication apparatus so that a start timing of a first frame included in the first signal sequence matches a start timing of a second frame included in the second signal sequence, the first signal sequence and the second signal sequence being received by the communication terminal.

### (Supplementary Note 7)

The control apparatus according to any one of supplementary notes 1 to 6, wherein the estimation unit estimates the delay time based on information about a propagation time of data between the non-terrestrial communication apparatus and the terrestrial communication apparatus.

### (Supplementary Note 8)

The control apparatus according to any one of supplementary notes 1 to 6, wherein the estimation unit estimates the delay time based on a distance between the non-terrestrial communication apparatus and the terrestrial communication apparatus.

### (Supplementary Note 9)

A communication system comprising:
a non-terrestrial communication apparatus;
a terrestrial communication apparatus; and
a control apparatus comprising:
   a communication unit configured to communicate with the non-terrestrial communication apparatus and the terrestrial communication apparatus;
   an estimation unit configured to estimate a delay time of communication with a communication terminal through the non-terrestrial communication apparatus from communication with the communication terminal through the terrestrial communication apparatus; and
   a control unit configured to, when MIMO communication is performed with the communication terminal using the non-terrestrial communication apparatus and the terrestrial communication apparatus, control an insertion timing of reference signals to be inserted into a first signal sequence transmitted to the non-terrestrial communication apparatus and a second signal sequence transmitted to the terrestrial communication apparatus, based on the delay time.

### (Supplementary Note 10)

The communication system according to supplementary note 9, wherein at a timing when the control unit inserts the reference signals into one of the first signal sequence and the second signal sequence and transmits the one of the first signal sequence and the second signal sequence, the control unit does not insert the reference signals into another one of the first signal sequence and the second signal sequence.

### (Supplementary Note 11)

A control method comprising:
estimating a delay time of communication with a communication terminal through a non-terrestrial communication apparatus from communication with the communication terminal through a terrestrial communication apparatus; and
controlling, when MIMO communication is performed with the communication terminal using the non-terrestrial communication apparatus and the terrestrial communication apparatus, an insertion timing of reference signals to be inserted into a first signal sequence transmitted to the non-terrestrial communication apparatus and a second signal sequence transmitted to the terrestrial communication apparatus, based on the delay time.

### (Supplementary Note 12)

A program for causing a computer to execute:
estimating a delay time of communication with a communication terminal through a non-terrestrial communication apparatus from communication with the communication terminal through a terrestrial communication apparatus; and
controlling, when MIMO communication is performed with the communication terminal using the non-terrestrial communication apparatus and the terrestrial communication apparatus, an insertion timing of reference signals to be inserted into a first signal sequence transmitted to the non-terrestrial communication apparatus and a second signal sequence transmitted to the terrestrial communication apparatus, based on the delay time.

Some or all of elements (e.g., structures and functions) specified in Supplementary Notes 2 to 8 dependent on Supplementary Note 1 may also be dependent on Supplementary Note 9 Supplementary Note 11 and Supplementary Note 12 in dependency similar to that of Supplementary Notes 2 to 8 on Supplementary Note 1. Some or all of elements specified in any of Supplementary Notes may be applied to various types of hardware, software, and recording means for recording software, systems, and methods.

What is claimed is:

1. A control apparatus comprising:
at least one memory storing instructions, and
at least one processor configured to execute the instructions to;
communicate with a non-terrestrial communication apparatus and a terrestrial communication apparatus;
estimate a delay time of communication with a communication terminal through the non-terrestrial communication apparatus from communication with the communication terminal through the terrestrial communication apparatus; and
when MIMO communication is performed with the communication terminal using the non-terrestrial communication apparatus and the terrestrial communication apparatus, control an insertion timing of reference signals to be inserted into a first signal sequence transmitted to the non-terrestrial communication apparatus and a second signal sequence transmitted to the terrestrial communication apparatus, based on the delay time.

2. The control apparatus according to claim 1, wherein at a timing when the reference signals are inserted into one of the first signal sequence and the second signal sequence, the at least one processor is further configured to execute the instructions not to insert the reference signals into another one of the first signal sequence and the second signal sequence.

3. The control apparatus according to claim 2, wherein the at least one processor is further configured to execute the instructions to identify first data included in the first signal sequence and second data included in the second signal sequence to be received by the communication terminal at substantially the same timing, and insert the reference signals into either of the first data and the second data based on the delay time.

4. The control apparatus according to claim 2, wherein
each of the first signal sequence and the second signal sequence is composed of a plurality of frames, and
the at least one processor is further configured to execute the instructions to switch a signal sequence into which the reference signals are inserted by a unit of the frame.

5. The control apparatus according to claim 2, wherein
the first signal sequence and the second signal sequence are signal sequences having communication resources in a time axis direction, and
the at least one processor is further configured to execute the instructions to alternately arrange the reference signals to be transmitted to the non-terrestrial communication apparatus and the reference signals to be transmitted to the terrestrial communication apparatus in the time axis direction.

6. The control apparatus according to claim 1, wherein
each of the first signal sequence and the second signal sequence is composed of a plurality of frames, and
the at least one processor is further configured to execute the instructions to control a timing at which the first signal sequence is transmitted to the non-terrestrial communication apparatus and a timing at which the second signal sequence is transmitted to the terrestrial communication apparatus so that a start timing of a first frame included in the first signal sequence matches a start timing of a second frame included in the second signal sequence, the first signal sequence and the second signal sequence being received by the communication terminal.

7. The control apparatus according to claim 1, wherein the at least one processor is further configured to execute the instructions to estimate the delay time based on information about a propagation time of data between the non-terrestrial communication apparatus and the terrestrial communication apparatus.

8. The control apparatus according to claim 1, wherein the at least one processor is further configured to execute the instructions to estimate the delay time based on a distance between the non-terrestrial communication apparatus and the terrestrial communication apparatus.

9. A control method comprising:
estimating a delay time of communication with a communication terminal through a non-terrestrial communication apparatus from communication with the communication terminal through a terrestrial communication apparatus; and
controlling, when MIMO communication is performed with the communication terminal using the non-terrestrial communication apparatus and the terrestrial communication apparatus, an insertion timing of reference signals to be inserted into a first signal sequence transmitted to the non-terrestrial communication apparatus and a second signal sequence transmitted to the terrestrial communication apparatus, based on the delay time.

10. The control method according to claim 9, wherein at a timing when the reference signals are inserted into one of the first signal sequence and the second signal sequence, the reference signals are not inserted into another one of the first signal sequence and the second signal sequence.

11. The control method according to claim 10, wherein first data included in the first signal sequence and second data included in the second signal sequence to be received by the communication terminal at substantially the same timing are identified and the reference signals into either of the first data and the second data based on the delay time are inserted.

12. The control method according to claim 10, wherein
each of the first signal sequence and the second signal sequence is composed of a plurality of frames, and
a signal sequence into which the reference signals are inserted is switched by a unit of the frame.

13. The control apparatus according to claim 10, wherein
the first signal sequence and the second signal sequence are signal sequences having communication resources in a time axis direction, and
the reference signals to be transmitted to the non-terrestrial communication apparatus and the reference signals to be transmitted to the terrestrial communication apparatus are alternately arranged in the time axis direction.

14. The control method according to claim 9, wherein
each of the first signal sequence and the second signal sequence is composed of a plurality of frames,
a timing at which the first signal sequence is transmitted to the non-terrestrial communication apparatus and a timing at which the second signal sequence is transmitted to the terrestrial communication apparatus are controlled so that a start timing of a first frame included in the first signal sequence matches a start timing of a second frame included in the second signal sequence, and
the first signal sequence and the second signal sequence are received by the communication terminal.

15. The control method according to claim 9, wherein the delay time is estimated based on information about a propagation time of data between the non-terrestrial communication apparatus and the terrestrial communication apparatus.

16. The control method according to claim 9, wherein the delay time is estimated based on a distance between the non-terrestrial communication apparatus and the terrestrial communication apparatus.

17. A non-transitory computer readable medium storing a program for causing a computer to execute:
estimating a delay time of communication with a communication terminal through a non-terrestrial communication apparatus from communication with the communication terminal through a terrestrial communication apparatus; and
controlling, when MIMO communication is performed with the communication terminal using the non-terrestrial communication apparatus and the terrestrial communication apparatus, an insertion timing of reference signals to be inserted into a first signal sequence transmitted to the non-terrestrial communication apparatus and a second signal sequence transmitted to the terrestrial communication apparatus, based on the delay time.
